(19) United States
(12) Patent Application Publication
(10) Pub. No.: US 2008/0048956 A1
(43) Pub. Date: Feb. 28, 2008

(54) Color management system and method for a visual display apparatus

(75) Inventors: David W. Rekieta, Van Alstyne, TX (US); Nguyen Ho, Highland Village, TX (US); Getzel Gonzalez Garcia, Flower Mound, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/507,844

(22) Filed: Aug. 22, 2006

(51) Int. Cl. G09G 3/34

(52) U.S. Cl. 345/84

(57) ABSTRACT

According to one embodiment of the present invention, a color management system for a visual display apparatus comprises a light source operable to produce a light beam having at least one color component, wherein at least one color component has a plurality of visual characteristics defining the quality of the color component. The system also has a light modulator operable to modulate the light beam into the image for displaying upon a display, an illumination sensor operable to monitor at least one visual characteristic of the at least one color component, and a feedback controller that is operable to modify the relative intensity of at least one color component due to deviation of the at least visual characteristic of at least one color component from at least one visual characteristic value during operation of the system.

### FIELD OF THE INVENTION

This invention relates to visual display devices, and more particularly, to a color management system for a visual display apparatus.

### BACKGROUND OF THE INVENTION

One of the earliest devices capable of displaying images is the conventional cathode ray tube, which is commonly referred to as a “CRT”. However, newer versions of visual display devices that enable the display of images includes a class of devices called light modulators. This type of device has either a reflective or refractive surface that is adapted to convert a light beam into a two-dimensional image for display upon virtually any planar surface. These devices operate to modulate an existing light beam emanating from a light source into the image suitable for display.

### SUMMARY OF THE INVENTION

According to one embodiment of the present invention, a color management system for a visual display apparatus comprises a light source operable to produce a light beam having at least one color component, wherein at least one color component has a plurality of visual characteristics defining the quality of the color component. The system also has a light modulator operable to modulate the light beam into the image for displaying upon a display, an illumination sensor operable to monitor at least one visual characteristic of the at least one color component, and a feedback controller that is operable to modify the relative intensity of at least one color component due to deviation of the at least one visual characteristic of at least one color component from at least one visual characteristic value during operation of the system.

According to another embodiment of the present invention, a method for controlling an image emanating from a visual display apparatus comprises the acts of measuring at least one visual characteristic of a light source having at least one color component, at least one color component having at least one visual characteristic, comparing at least one visual characteristic to at least one visual characteristic value, and then adjusting the intensity of at least one color component due to deviation of at least one visual characteristic from at least one visual characteristic value.

Some embodiments of the present invention may provide numerous technical advantages. A particular technical advantage of one embodiment may include the ability to mitigate the adverse affects of deviation of the light source due to varying ambient conditions or situations that the light source may be operating under. In this manner, the coloration or hue of the image that is displayed is adjusted to be more consistent and may more closely represent the hue of the actual image to be displayed. Additionally, the color management system may be adapted to adjust the coloration of the image over several differing brightness levels. Therefore, the coloration of the image may be adapted to be more consistent from dark, wherein all color components are in the ‘OFF’ state to white, wherein all color components are in the ‘ON’ state.

An additional advantage that may be provided is that the light source may be continually adjusted for a relatively higher brightness level. Production of the light beam at a relatively higher brightness level enables a relatively sharper image resolution as perceived by a user, particularly in higher ambient lighting conditions. Additionally, adjusting the light source for a relatively higher brightness level alleviates the amount of ‘de-rating’ that the light source must be designed for.

While specific advantages have been disclosed hereinabove, it will be understood that various embodiments may include all, some, or none of the previously disclosed advantages. Other technical advantages may become readily apparent to those skilled in the art of visual display apparatuses.

### BRIEF DESCRIPTION OF THE DRAWINGS

A more complete understanding of example embodiments of the invention will be apparent from the detailed description taken in conjunction with the accompanying drawings in which:

FIG. 1 is a block diagrammatic view of one embodiment of a color management system for a visual display apparatus of the present invention;

FIG. 2 is a graphical representation of test results of several sample light emitting diodes' dominant wavelength of visual radiation due to changes in ambient temperature;

FIG. 3 is a graphical representation of test results of several sample light emitting diodes dominant wavelength of visual radiation due to changes in quiescent current;

FIG. 4 is a chromaticity diagram showing the relative dominant wavelength or color hues of a plurality of sets of red, green, and blue light emitting diodes or changes due to temperature;

FIG. 5 is a diagrammatic view of several components that are associated with the optical path of the embodiment of FIG. 1; and

FIG. 6 is a flow diagram is a method of adjusting the relative luminous intensity of each of the color components of the light source due to changes in the visual characteristics thereof according to the present invention.

### DETAILED DESCRIPTION

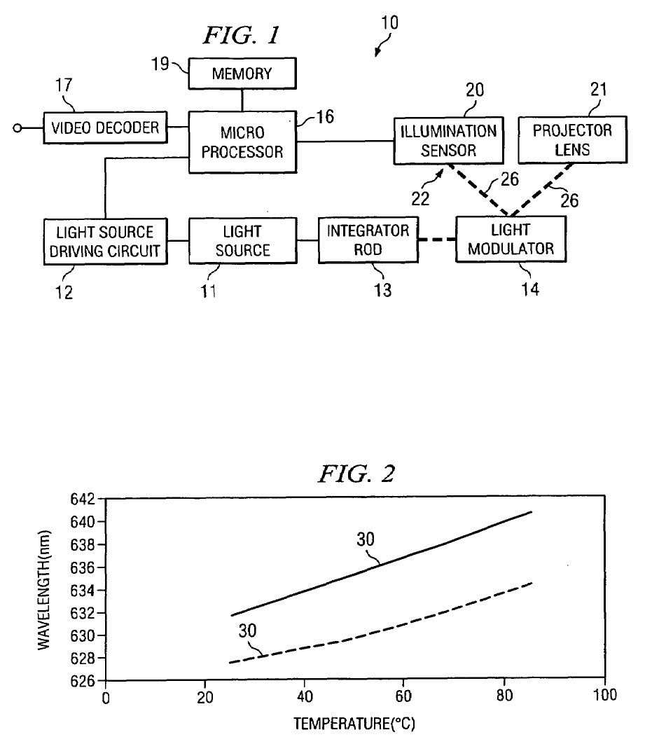

Reference will now be made to the drawings, wherein a color management system and method for a visual display apparatus 10 is shown. Specifically as shown in FIG. 1, color management system 10 generally comprises a light source 11 that is driven by a light source driving circuit 12, an optional integrator rod 13, a light modulator 14, a micro-processing circuit 16, a video decoder 17, memory 19, an illumination sensor 20, and a projector lens 21. The system is particularly adapted for the display of images via the light modulator 14 that reflects or refracts selective portions of light emanating from the light source 11 to a two-dimensional image that is then refracted by the projecting lens 21 for display on a surface (not specifically shown). The image may include a plurality of pixels arranged in a N number of rows by a M number of columns, thereby forming the image having height equal to N * (pixel size) and a width equal to M * (pixel size).

In one embodiment, the light modulator 14 may have a plurality of reflective elements corresponding to the arrangement and quantity of pixels to be displayed in the image. One device particularly suited to provide such an arrangement and quantity of reflective pixilated reflective surfaces is a digital micro-mirror device (DMD) available from Texas Instruments Inc., located in Dallas, Tex. The digital micro-mirror device has a plurality of reflective surfaces arranged in an M×N configuration that are adapted to selectively reflect light emanating from the light source to or away from the projecting lens. When coordinated together, the plurality of reflective surfaces are operable to create an image that is refracted by the projecting lens 21 for display upon the planar surface. Although the embodiment as shown in the drawings utilizes a digital micro-mirror device 14 incorporating multiple reflective surfaces for conversion of light emanating from the light source 11 to an image, other types of light modulators 14 may also benefit from the teachings of the present invention.

Power to the light source 11 may be driven by light driver circuit 12 that is in turn, controlled by a micro-processor circuit 16. The micro-processor circuit 16 is configured to convert signals outputted from the video decoder 17 into signals representative of an image to be displayed by the system 10. Correspondingly, the video decoder 17 may be adapted to input any type of signal representative of a still or moving video image including S-video, digital video input (DVI), composite video, component video signals, and the like.

The light source 11 may comprise any light generating element capable of generating radiant energy in the visual light spectrum. Examples of such light generating elements suitable for this type of purpose includes light emitting diodes (LEDs), Lasers, incandescent lighting, sodium vapor, metal halide, Xenon, high-pressure mercury, fluorescent, tungsten-halogen lamps, and the like or some combination of either of these light generating elements. Nevertheless, for light generating elements having a spectral pattern that spans over a major portion of the visual light spectrum, a color wheel or other similar type element may be used to generate the plurality of individual color components to be used with the system. The visual light spectrum is defined within this disclosure as the entire band of electro-magnetic energy that is visible to the human eye, which is generally accepted to include wavelengths extending from the near infrared region to the near-ultraviolet region. Light generating elements such as LEDs and Lasers provide advantages in that the spectral pattern generated thereby is relatively narrow, thereby eliminating the need for light filtering mechanisms such as the color wheel.

In addition to their relatively narrow spectral pattern, LEDs provide other advantages over other previously mentioned light generating sources. For example, LEDs are generally smaller in physical size than other light generating sources, therefore providing for packaging of the system 10 in a relatively smaller size. LEDs operate according to basic solid-state device principles, thereby allowing for operation over a wide temperature range as well as abating the need for warm-up prior to use. Nevertheless, incorporation of LEDs within the color management system 10 of the present invention presents several problems with their use. FIGS. 2 through 4 depict graphical representations of test data representative of the characteristic deviation in performance of test LEDs due to varying types of operating conditions.

FIG. 2 shows a graphical representation of the relative performance measurements 30 of two sample test LEDs due to changes in ambient temperature. The Y-scale indicates the dominant wavelength, wherein the dominant wavelength is defined as the specific wavelength of maximal luminous intensity that propagates from the test LED under a given operating condition. Thus, changes in ambient temperature have a direct, adverse effect upon the system's ability to accurately reproduce color characteristics of the image to be displayed.

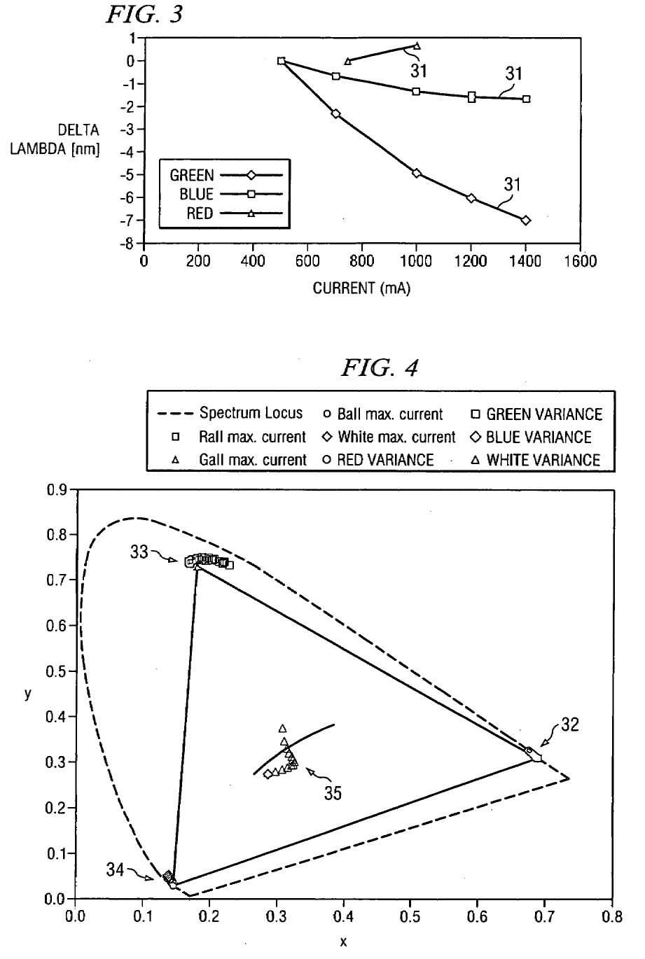

FIG. 3 shows a graphical representation of the relative performance measurements 31 of sample red, green, and blue LEDs according to changes in quiescent operating current. The Y-axis of the graph of FIG. 3 indicates the dominant wavelength and the X-axis shows the quiescent current through each sample LED. As shown in the drawing, an increase in static current yields a corresponding decrease or increase in dominant wavelength of the test LEDs.

In addition to ambient temperature and operating current, other factors that may influence the operating characteristics of LEDs may include the lifetime of the LED, duty cycle of operation, frequency of operation, and distribution among a plurality of LEDs manufactured according to a predetermined manufacturing process, just to name a few. For example, FIG. 4 shows a chromaticity diagram in which the measured dominant wavelength of a red 32, green 33, and blue 34 LED color varies due to temperature variations as a result of continued operation of the LED. Disposed in between each of the individual color components of the graph of FIG. 4 is another distribution of measured values 35, termed the white point, resulting from the distribution of values of each constituent color component. The white point is defined as the resulting color that is perceived by the human eye in response to all constituent color components being in the ‘ON’ state.

Color management system 10 provides a solution to the usage of LEDs as the light source 11 in a visual display apparatus by enabling modification of the visual characteristics of the LEDs due to changes in operating conditions encountered thereby. In this manner, inherent changes in the visual characteristics of the LED due to varying operating conditions can be mitigated, thereby enabling an image that more accurately represents the visual characteristics of the original image.

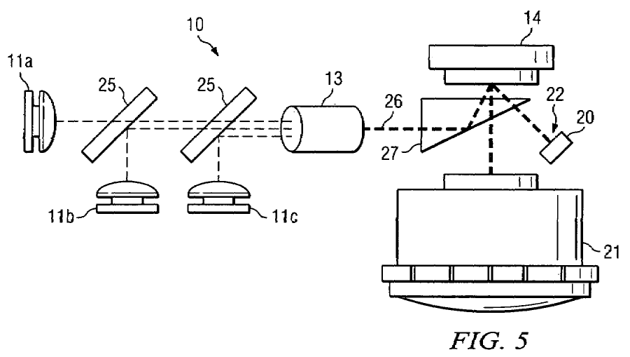

Referring now to FIG. 5, several components forming an optical path of the color management system for visual display apparatus 10 are shown. Visible light may be generated by the light source 11 having one or more color components (11a, 11b, and 11c). If more than one color components 11 are implemented, one or more reflecting elements 25 may be used to combine the light beam emanating from each color component into a single co-axially oriented light beam. Although the present embodiment incorporates reflective elements 25 to combine the light beam, it will be appreciated that refractive elements may also be used to accomplish a similar result. Optical integrator rod 13 is optionally disposed within the path of the light beam 26 in order to evenly distribute each of the individual color components throughout the light beam's cross section. Following the optical integrator 13 in the path of the light beam 26 is a prism 27 that bends the light towards the light modulator 14. As described above, the light modulator 14 is operable to alternatively direct portions of the light beam 26 towards the projection lens 21 or to an illumination sensor 20 located in the dump area 22.

According to one embodiment, the illumination sensor 20 is disposed within the dump area 22 of the optical path in order to measure at least one visual characteristic of the light beam 26. Given information provided by sensor 20, the light beam 26 may be modified due to inherent deviation of each of the color components from an accepted norm during operation of the system 10. Other embodiments may comprise an illumination sensor 20 that is adapted to measure the light beam 26 at any point within the optical path. For example, a refractive element may be disposed after reflective elements 25 and before the optional integrator rod 13 to divert a portion of the light beam 26 onto the illumination sensor 20. Thus, it will be appreciated that the illumination sensor 20 may be adapted to measure the visual characteristics of the light beam 26 from any point along the optical path 26.

Disposal of the illumination sensor 20 within the dump area 22 of the optical path enables the color management system to make use of periodic dark times of the display with which to take visual characteristic measurements. These periodic dark times extend for several micro-seconds, thereby remaining relatively unnoticed by the user of the system 10. However, these several micro-seconds provide ample time for the system take measurements of the current visual characteristic of each color component and then make necessary adjustments to each of the color components 11.

In one embodiment, adjustments to each of the color components 11 may be accomplished by varying the static or quiescent current flowing through each respective color component. If each of the color components comprises a LED, the relative luminous intensity of the color component 11a, 11b, or 11c is directly proportional to current flow through the diode. Therefore, a proportional change of quiescent current yields a corresponding proportional change in relative luminous intensity. Another optional embodiment may incorporate a periodic on/off current source to the color component 11, such as a square wave having an adjustable duty cycle similar to a pulse width modulation (PWM) system to adjust the relative luminous intensity outputted from its respective color component. Another embodiment that may provide for the adjustment of the light beam comprises adjustment of the duty cycle at which each pixel of the light modulator 14 is assigned to an ‘ON’ state.

If the image is to be depicted in color, a plurality of color components 11, defining a set of primary colors, may be superimposed upon each pixel of the display in order to represent varying visual colors of the color spectrum. The relative amount of each color relative to the other colors that is directed onto each pixel determines the hue and the cumulative intensity of all the color components determines the overall brightness of the pixel. The light beam can be adjusted to a desired white point by adjustment of each of the color component's relative light intensity. In one embodiment, the light beam from all color components are directed to the illumination sensor 20 during the periodic dark time of the system. While the light beam 26 is directed at the illumination sensor 20, the relative luminous intensity of each constituent color component can be measured and adjusted for any changes the may have occurred in the visual characteristics thereof due to changes in operating conditions. In another embodiment, a plurality of measurements may be acquired for each color component over a range of brightness levels such that the light beam may be adjusted for changes in visual characteristics in several overall brightness levels ranging from dark, wherein all color components are in the ‘OFF’ state, to white, wherein all color components are in the ‘ON’ state.

The chromaticity diagram of FIG. 4 shows the possible hues that each pixel of an image may possess due to proportional mixing of each of the color components 11. The chromaticity diagram shows that all colors may be mapped to x and y values in order to mathematically represent the possible hues or available color gamut within the system 10. Another variable Y may be incorporated to denote brightness or luminous intensity, wherein variables x, y, and Y provides a comprehensive characterization of the light beam. Thus, to determine the relative intensity of each color component from the light beam from which all color components are in the ‘ON’ state, the light intensity necessary from each color component (C₁, C₂, and C₃) necessary to achieve a desired white point may be calculated according to the following formulae:

$${C}_{1} = \frac{X}{X + Y + Z} {C}_{2} = \frac{Y}{X + Y + Z} {C}_{3} = \frac{Z}{X + Y + Z}$$

$$where \text{:}$$

$$X = \frac{x}{y} Y Z = \frac{1 - x - y}{y} Y$$

Therefore, given measurement values obtained by the illumination sensor 20 during the dark time of the display, an accurate error value can be calculated. Error values obtained for each color component may then be applied to the light source driving circuit 12 or the quiescent duty cycle of each pixel in the light modulator 14 in order to cancel any deviation that may have occurred in the light source 11.

The embodiment as described above was implemented using a light source comprising three color components 11. However, it will be understood that the acts of measuring and adjusting a light source 11 may also be implemented on light sources having any number of color components 11. For example, if an image comprising only a black-and-white image is desired, a light source 11 having only one color component may be used. Conversely, a light source having four or more color components may also be implemented using the teachings of the present invention. In one embodiment, the three color components may comprise red, green, and blue color hues. In another embodiment, the three color components may comprise yellow, magenta, and cyan.

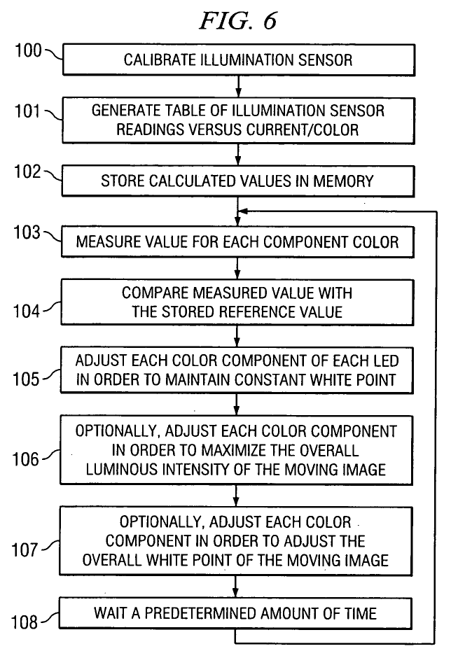

FIG. 6 shows a flowchart indicating the sequence of acts that are performed to implement the color management system for a visual display apparatus of the present invention. In step 100, the illumination sensor 20 may optionally be calibrated against a reference light source (not specifically shown) having known visual characteristics. In an alternative embodiment, the illumination sensor's visual characteristics possess a tolerance that does not necessitate initial calibration in which case act 100 may be omitted. The reference light source may be used following final assembly of the system in a manufacturing environment and thus may not be packaged within the system's housing. One of the purposes of calibrating the illumination sensor is to ensure that all further measurements taken with the color management system are taken against a known, established reference value. Following calibration of the illumination sensor 20, a calibration table is populated with numeric values representing a reference visual characteristic for each color component 11, 101.

In one embodiment, one numeric value representing a reference visual characteristic may be stored in the calibration table for each color component. In another embodiment, a plurality of numeric values representing a plurality of reference visual characteristics may be stored in the calibration table for each color component. The plurality of numeric values may correspond to a plurality of generally equally spaced apart luminous intensity levels for its respective color component, wherein the luminous intensity levels may extend from maximum luminous intensity to an off state of the color component. In this manner, the desired white point may be controlled over differing levels of brightness of the display. Following creation of the plurality of numeric value representing the plurality of visual characteristics, the calibration table is stored in memory 19 (act 102).

Following initial calibration 100, generation of reference values 101, and storage of these reference values in memory 102, the system 10 is then packaged and available for use by the user. Although the previous acts will not be used again by the system under normal operating conditions, it may be desired to occasionally check the reference values contained in the table against the reference light source during the service life of the visual display apparatus 10. Such a case may exist wherein the visual display apparatus 10 is repaired via replacement of the illumination sensor 20 or other similar type component.

In operation, each color component is periodically measured to determine at least one visual characteristic of each color component of the light source 11 that is displayed upon the display 103. In one embodiment, this measurement is taken periodically during a short, momentary dark time of the system 10. In other embodiments, measurements may be taken continuously by diversion of a portion of the optical path to the illumination sensor 20. The measurements taken in 103 are then compared against the reference visual characteristic that was created in act 101 (act 104). The light source 11 is then adjusted, according to negative feedback, in order to maintain a relatively constant white point that is displayed upon the display 105. In one embodiment, the light source 11 is adjusted via a corresponding adjustment of the light source 11. In another embodiment, the light source 11 is adjusted by adjustment of the duty cycle of each pixel produced by the light modulator 20.

In an alternative embodiment, each color component may be individually adjusted in order to enhance the relative brightness of the light source while maintaining a relatively constant white point 106. It would be beneficial to implement a light source having the brightest possible luminous intensity. However in situations incorporating the use of LEDs, the possibility of overdriving the LED causes the quiescent drive current to be set well below its maximum allowable level or what is known in the art as ‘de-rating’ a component. The LED is de-rated to ensure that the system may operate in all specified operating conditions without severe degradation to the performance of the LED. For example, a conventional visual display apparatus operating at 60 degrees Fahrenheit would be configured to have the same maximum luminous intensity as when operated at 80 degrees Fahrenheit. Thus, the LED would not be driven to its maximum capability when operated at the lower ambient temperature of 60 degrees Fahrenheit. The present invention provides a solution to this need by comparing the luminous intensity of each color component with the other color components in order to determine the maximum luminous intensity that is available during any given operating condition in order to produce a generally constant white point.

In another embodiment, each color component may be individually adjusted against the other color components in order to shift the overall hue of the display to suit the user's tastes 107. Whereas one particular user may wish the resulting display to exhibit a warmer tone, the light source 11 may be adjusted by the user to augment the ‘red-ish’ color components while simultaneously reducing the ‘blue-ish’ color components. Conversely, the above process is reversed if the user wishes the resulting display to exhibit a cooler color tone.

Following adjustment of each of the color components 11, the system then waits a predetermined amount of time before again sequencing through acts 103-108 (108).

Thus, a system and method are provided that allows adjustment of a light source in order to maintain a desired white point of a visual display apparatus 10, wherein the adverse effects upon the light source's performance are effectively mitigated.

Although the present invention and its advantages have been described in detail, it should be understood that various changes, substitutions, and alterations can be made therein without departing from the spirit and scope of the invention as defined by the appended claims.

What is claimed is:

1. A system for displaying an image comprising:
a light source comprising a plurality of light emitting diodes, wherein each of the diodes are adapted to produce visible light of a differing color, each of the light emitting diodes having a plurality of visual characteristics defining the quality of the light emitting diode;
a digital micro-mirror device operable to convert the light beam to the image for displaying upon a display;
an illumination sensor for monitoring at least one visual characteristic of each of the light emitting diodes; and
a feedback controller that is operable to modify the relative intensity of a particular one of the plurality of light emitting diodes due to deviation of the visual characteristic of the particular one from a visual characteristic value during operation of the system.

2. The system of claim 1, wherein the at least one visual characteristic is the dominant wavelength of the light emitting diode.

3. The system of claim 1, wherein the plurality of color components are two or more color components.

4. A system for displaying an image comprising:
a light source operable to produce a light beam having at least one color component, the at least one color component having a plurality of visual characteristics defining the quality of the color component;
a light modulator operable to modulate the light beam into the image for displaying upon a display;
an illumination sensor operable to monitor at least one visual characteristic of the at least one color component; and
a feedback controller that is operable to modify the relative intensity of the at least one color component due to deviation of the at least visual characteristic of the at least one color component from at least one visual characteristic value during operation of the system.

5. The system of claim 4, wherein the at least one visual characteristic is a visual characteristic that is selected from the group consisting of luminous intensity and dominant wavelength.

6. The system of claim 5, wherein the at least one color components is a plurality of color components.

7. The system of claim 6, wherein the plurality of color components are three color components.

8. The system of claim 7, wherein the three color components are selected from the group consisting of red, green, and blue, yellow, magenta, and cyan.

9. The system of claim 4, wherein the light modulator is a digital micro-mirror display.

10. The system of claim 4, wherein the illumination sensor is disposed in a dump area of the digital micro-mirror display.

11. The system of claim 10, wherein the feedback controller is configured to receive the at least one visual characteristic from the illumination sensor during a periodic dark time of the system.

12. The system of claim 10, wherein the feedback controller is configured to continuously receive the at least one visual characteristic from the illumination sensor by diversion of a portion of the optical path to the illumination sensor.

13. The system of claim 4, wherein the light source comprises at least one light emitting diode operable to generate the at least one color component.

14. The system of claim 4, wherein the at least one visual characteristic value may be modified to a new visual characteristic value during operation of the system.

15. The system of claim 4, wherein the visual characteristic value comprises a plurality of visual characteristic values, each of the visual characteristic values corresponding to measurements taken from the at least one color component at generally equally spaced light intensity levels.

16. A method for controlling an image emanating from a visual display apparatus comprising:
measuring at least one visual characteristic of at least one color component of a light source;
comparing the at least one visual characteristic to at least one visual characteristic value; and
adjusting the intensity of the at least one color component due to deviation of the at least one visual characteristic from the at least one visual characteristic value.

17. The method of claim 17, further comprising:
diverting a portion of the light source away from a display to an illumination sensor.

18. The method of claim 17, further comprising:
generating a plurality of the visual characteristic values such that each of the visual characteristic values corresponds to one of a plurality of equally spaced luminous intensity values of the at least one color component.

19. The method of claim 17, further comprising:
calculating the visual characteristic value for each said color component necessary such that a desired white point is achieved.

20. The method of claim 17, further comprising:
prior to the act of measuring the at least one visual characteristic, calibrating the illumination sensor against a reference light source having at least one visual characteristic value.
